(19) United States
(12) Patent Application Publication
(10) Pub. No.: US 2026/0210825 A1
(43) Pub. Date: Jul. 23, 2026

(54) SYSTEMS AND METHODS FOR MONITORING HYDRATE INHIBITOR CONCENTRATION IN AQUEOUS SOLUTIONS

(71) Applicant: CAMERON INTERNATIONAL CORPORATION, Houston, TX (US)

(72) Inventors: Massimiliano FIORE, Singapore (SG); Cheng-Gang XIE, Singapore (SG); Guillaume JOLIVET, Clamart (FR); Linyuan ZHAN, Singapore (SG); Harald SOLHEIM, Bergen (NO); Luke LIM, Singapore (SG)

(21) Appl. No.: 19/141,058

(22) PCT Filed: Dec. 19, 2023
(86) PCT No.: PCT/US2023/084767

§ 371 Date: Jun. 19, 2025

(30) Foreign Application Priority Data
Dec. 29, 2022 (SG) 10202260624Q

(51) Int. Cl. G01N 9/36; C09K 8/52; E21B 41/00

(52) U.S. Cl. CPC G01N 9/36; C09K 8/52; E21B 41/00; C09K 2208/22

(57) ABSTRACT

A system includes a processor and a memory, accessible by the processor, the memory storing instructions that, when executed by the processor, cause the processor to receive, from a density sensor with an integrated temperature probe, first data indicative of a density of an aqueous liquid flowing through a line, and second data indicative of a temperature of the aqueous liquid flowing through the line, receive, from an electromagnetic sensor, third data indicative of a dielectric property of the aqueous liquid flowing through the line, apply an interpretation model to the first data, the second data and the third data to determine a concentration of hydrate inhibitor of the aqueous liquid flowing through the line based on the density, the temperature and the dielectric property of the aqueous liquid flowing through the line, and generate an indication of the concentration of hydrate inhibitor of the aqueous liquid flowing through the line.

### CROSS-REFERENCE TO RELATED APPLICATIONS

The present application claims priority benefit of Non-Provisional Patent Application No. 10202260624Q, filed Dec. 29, 2022 in Singapore, the entirety of which is incorporated by reference herein and should be considered part of this specification.

### BACKGROUND

The present disclosure relates generally to oil and gas wells, and more specifically, to determining concentrations of a hydrate inhibitor, such as monoethylene glycol (MEG), in aqueous liquids at one or more points in the hydrate inhibitor reclamation system for an oil and gas well.

Hydrate inhibitors, such as MEG, are sometimes used in oil and gas wells with co-produced water to reduce or eliminate methane hydrate formation, especially in oil and gas wells that experience high pressures and low temperatures, such as subsea wells with long subsea flowlines. However, hydrate inhibitors are expensive relative to other chemicals used in producing and operating oil and gas wells. Accordingly, hydrate inhibitors reclamation systems are used to reclaim and reuse hydrate inhibitors in the oil and gas well to reduce operating costs. At various points within a hydrate inhibitor reclamation system, the hydrate inhibitor, such as MEG, may be mixed with water of a salinity to form an aqueous liquid that is pre-separated from co-produced hydrocarbons oil and gas. Being able to determine the hydrate inhibitor concentration and salinity of the aqueous liquid flowing through various locations of the hydrate inhibitor MEG reclamation system is desired to improve the operation and efficiency of hydrate inhibitor reclamation systems.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The disclosed techniques are directed to using one or more sensors to determine a concentration of a hydrate inhibitor, such as monoethylene glycol (MEG) and, in some cases, a salinity in a MEG-water aqueous liquid flowing through a conduit. Though present techniques are described as applied to a hydrate inhibitor reclamation system of an oil and gas well, it should be understood that the disclosed techniques may be utilized in other applications, including other uses of hydrate inhibitors. A density sensor with an integrated temperature probe, such as a Coriolis meter, may be installed on a bypass line or a main line of a MEG-water aqueous liquid and configured to measure the density of the aqueous liquid flowing through the line and the temperature of the aqueous liquid flowing through the line (and, advantageously, the flow rate of the aqueous liquid flowing through the line). In some embodiments, a second electromagnetic sensor, such as an electrical conductivity sensor, a dielectric permittivity sensor, a microwave transmission sensor, or a microwave reflection sensor, etc. may be installed on the bypass line or the main line and configured to measure a dielectric property (e.g., conductivity and/or permittivity) of the aqueous liquid flowing through the line. In some embodiments, the second sensor may also be configured to measure a salinity of the aqueous liquid flowing through the line. An interpretation model may be created based on experimental data and applied to the measured data to determine the hydrate inhibitor concentration of the aqueous liquid flowing through the line. In some embodiments, the interpretation model may be applied to the measured data to determine the salinity (e.g., salt concentration) of the aqueous liquid flowing through the line. In one embodiment, the line may be fluidly coupled to an output of a flash drum of a pretreament section of a MEG reclamation system for an oil and gas well, in which the aqueous liquid (“rich MEG”) is a mixture of mainly sodium chloride salt water and MEG solution of a typical 40%~60% wt MEG. In other embodiments, the line may be fluidly coupled to an output of a MEG distillation column of a regeneration section of a MEG reclamation system for an oil and gas well, in which the aqueous liquid (“lean MEG”) is a MEG solution of a typical 80% ~90% wt MEG with largely no salt content in water.

In one embodiment a system includes a processor and a memory, accessible by the processor, the memory storing instructions that, when executed by the processor, cause the processor to receive, from a density sensor with an integrated temperature probe (such as a Coriolis meter), first data indicative of a density of an aqueous liquid flowing through a line, and second data indicative of a temperature of the aqueous liquid flowing through the line, apply an interpretation model to the first data and the second data to determine a concentration of MEG of the aqueous liquid flowing through the line based on the density and the temperature of the aqueous liquid flowing through the line, and generate an indication of the concentration of MEG of the aqueous liquid flowing through the line.

In another embodiment a method includes receiving, from a first sensor, first data indicative of a density of an aqueous liquid flowing through a line, and second data indicative of a temperature of the aqueous liquid flowing through the line, receiving, from a second electromagnetic sensor, third data indicative of a dielectric property of the aqueous liquid flowing through the line, applying an interpretation model to the first data, the second data, and the third data to determine a concentration of MEG of the aqueous liquid flowing through the line based on the density, the temperature, and the dielectric property of the aqueous liquid flowing through the line, and generating an indication of the concentration of MEG of the aqueous liquid flowing through the line.

In a further embodiment a non-transitory computer readable medium stores instructions that, when executed by a processor, cause the processor to receive, from a density sensor with an integrated temperature probe, first data indicative of a density of an aqueous liquid flowing through a line, and second data indicative of a temperature of the aqueous liquid flowing through the line, receive, from an electromagnetic sensor, third data indicative of a dielectric property of the aqueous liquid flowing through the line, applying an interpretation model to the first data, the second data, and the third data to determine a concentration of MEG of the aqueous liquid flowing through the line based on the density, the temperature, and the dielectric property of the aqueous liquid flowing through the line, and generating an indication of the concentration of MEG of the aqueous liquid flowing through the line.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic of an embodiment of a hydrate inhibitor, such as monoethylene glycol (MEG), reclamation system for an oil and gas well, in accordance with aspects of the present disclosure;

FIG. 2 is a schematic of an embodiment of a MEG concentration monitoring system that could be used in the MEG reclamation system of FIG. 1, in accordance with aspects of the present disclosure;

FIG. 3 is a schematic of an interpretation model for determining MEG concentration of an aqueous liquid based on various inputs, in accordance with aspects of the present disclosure;

FIG. 4 is a schematic of an interpretation model for determining MEG concentration and salinity of an aqueous liquid based on various inputs, in accordance with aspects of the present disclosure; and

FIG. 5 is a block diagram of example components of a computing device that could be used for data collection, data analysis, model generation, and so forth, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

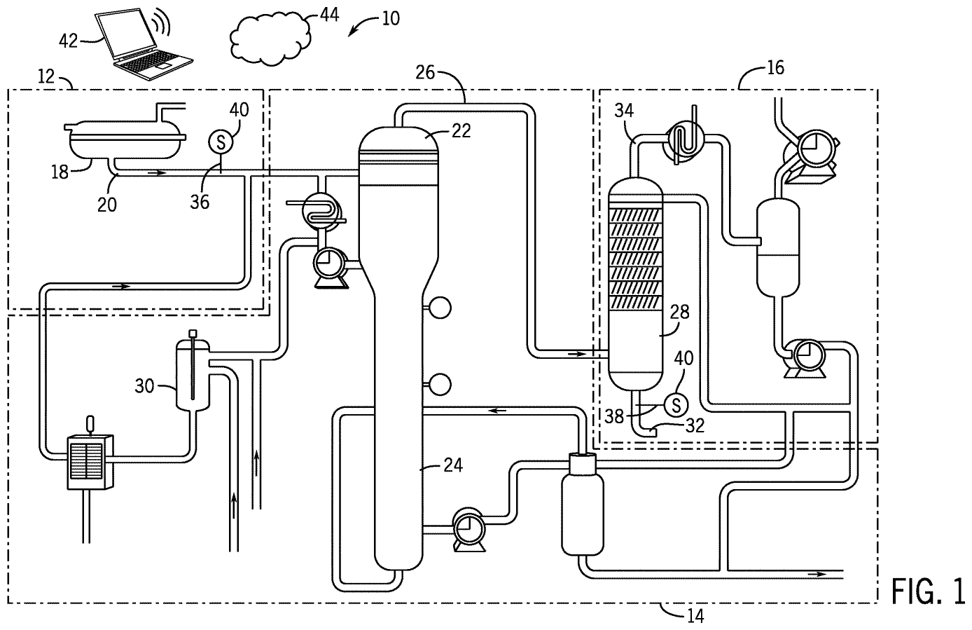

A hydrate inhibitor, such as monoethylene glycol (MEG) or methanol, is commonly used in oil and gas wells with co-produced water, especially those wells that experience high temperatures and low temperatures, such as subsea wells with long subsea flowlines, to reduce or eliminate hydrate formation. To conserve resources, and because MEG is expensive relative to other chemicals used in producing and operating oil and gas wells, MEG reclamation systems are used to reclaim, recover, and/or regenerate MEG and reuse it in the oil and gas well. FIG. 1 is a schematic of an embodiment of a MEG reclamation system 10. As shown, the MEG reclamation system 10 includes three sections based on the function of each section. A pretreatment section 12 receives a mixture of rich MEG and hydrocarbons, salt, and water output from an oil and gas well and removes hydrocarbons and impurities from the mixture, a reclamation section 14 removes salts, and a regeneration section 16 removes water, resulting in lean MEG, sometimes referred to as pure MEG, that can be injected back into the oil and gas well.

Specifically, in the pretreatment section 12, a mix of rich MEG (e.g., 40-60% weight MEG in an aqueous solution), hydrocarbons, salt, water, and various impurities output from an oil and gas well is received into a flash drum 18. The mixture is heated in the flash drum 18 to separate the various components in the mixture. A mixture of rich MEG, salt, and water flows out of a rich MEG, salt, and water line 20 to the reclamation section 14. Flash gas and a mixture of oil and hydrocarbon condensates flow out of respective lines for processing.

In the reclamation section 14, the rich MEG, salt, and water mixture enters a flash separator 22, which uses a recycle loop to heat the MEG and salt water mixture, causing the salts in the mixture to crystalize and descend down a brine column 24. A rich MEG and water mixture exits the flash separator 22 and travels along a MEG and water mixture line 26 to a MEG distillation column 28 of the regeneration section 16. The crystalized salts are collected at the bottom of the brine column 24, processed, and disposed of. If divalent salts are present, they may be removed by a separate divalent salt removal system 30.

In the regeneration section 16, the MEG and water mixture enters the MEG distillation column 28, which uses distillation to separate the MEG from the water to produce high quality, salt-free, lean MEG, sometimes referred to as pure MEG (80-95% weight MEG in an aqueous solution), which exits the distillation column 28 via a lean MEG line 32. Water flows out of the distillation column 28 via a water line 34.

Being able to determine the MEG concentrations of the aqueous liquids flowing through the MEG reclamation system 10 and various locations throughout the MEG reclamation system 10 in real time or near real time may help to improve control of the MEG reclamation system 10. Specifically, being able to determine the MEG concentration of the aqueous liquid mixture of rich MEG and salt water at an upstream location 36 flowing out of the flash drum 18 and through the rich MEG and salt water line 20, and the MEG concentration of the lean MEG at a downstream location 38 flowing out of the distillation column 28 and through the lean MEG line 32, would improve an operator's ability to control the MEG reclamation system 10. Because both the MEG and the salt in the MEG reclamation system 10 are soluble in water, and because of the fluctuations in temperature in the system, determining relatively small changes (e.g., ±1% wt) in MEG concentration, regardless of changes in salinity, at a particular location in real time or near real time is extraordinarily difficult. However, by using one or more sensors 40 to collect various measurements, such as the temperature, density, electrical conductivity and/or dielectric permittivity of the aqueous liquid mixture, and by using experimentally derived interpretation algorithms, MEG concentrations at the upstream location 36 and the downstream location 38, along with other locations within the MEG reclamation system 10, or other systems, can be determined. As described in more detail below, these sensors 40 may include a density sensor with an integrated temperature sensor, such as a Coriolis meter, and in some embodiments, an electromagnetic sensor such as a microwave reflection sensor.

At the upstream location, 36, the rich MEG mixture is characterized by a typical 40-60% weight MEG in an aqueous solution and includes salt and water. Accordingly, the MEG concentration of the mixture can be measured in the rich MEG, salt, and water line 20 with a typical salt concentration up to approximately 2% in mass. At the downstream location 38, the lean MEG mixture is characterized by a typical 80-90% weight MEG in aqueous solution, with very low or no salt content. As shown, in some embodiments, the MEG reclamation system 10 may include or be communicatively coupled to one or more computing devices 42 and/or one or more cloud/remote servers 44 via a local network, the internet, a cellular network, etc. The computing device 42 may include laptop, notebook, desktop, tablet, or workstation computers, as well as server type devices or portable, communication type devices, such as cellular telephones and/or other suitable computing devices. The one or more computing devices 42 and/or one or more cloud/remote servers 44 may be used for controlling components of the MEG reclamation system 10, collecting data from sensors 40, transmitting collected data, analyzing collected data, generating/training models, updating/retraining models, applying models to collected data, and so forth. The one or more computing devices 42 and/or the one or more cloud/remote servers 44 may be communicatively coupled to one another via a local network, the internet, a cellular network, and so forth.

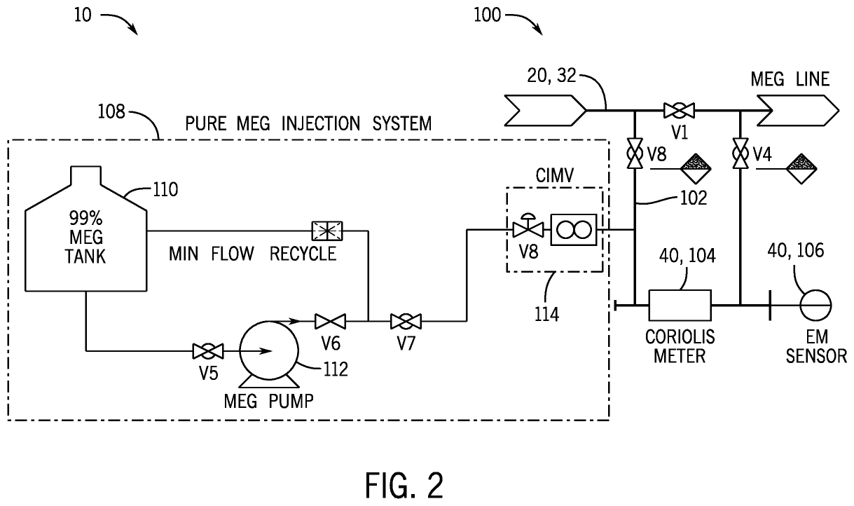

FIG. 2 is a schematic of an embodiment of a MEG concentration monitoring system 100 that may be used, for example, in the MEG reclamation system 10 of FIG. 1. In the embodiment shown in FIG. 2, the MEG concentration monitoring system 100 is fluidly coupled to, or in fluid communication with, the rich MEG, salt, and water line 20 if the MEG concentration monitoring system 100 is disposed at the upstream location 36, and fluidly coupled to, or in fluid communication with, the lean MEG line 32 if the MEG concentration monitoring system 100 is disposed at the downstream location 38. In the illustrated embodiment, the MEG concentration monitoring system 100 includes a bypass line 102 that diverts fluid from the rich MEG, salt, and water line 20 or the lean MEG line 32 for measurement. In such an embodiment, fluid rejoins the rich MEG, salt, and water line 20 or the lean MEG line 32 after measurement. However, it should be understood that embodiments are also envisaged that do not include a bypass line and sensors are disposed inline in the rich MEG, salt, and water line 20 and/or the lean MEG line 32. Generally, the bypass line may be used for systems with larger diameter pipes (e.g., approximately 6 inches and larger), whereas the sensors can be used in-line for systems with smaller diameter pipes (e.g., less than 6 inches) As shown, a density sensor with an integrated temperature probe 104, such as a Coriolis meter, or an oscillating U-tube density sensor, may be used to measure density and temperature of the MEG-water aqueous liquid flowing through the bypass line 102. The Coriolis meter may also be configured to measure the mass flow rate of the MEG-water aqueous liquid. A Coriolis meter 104 utilizes the principles of the Coriolis effect to determine the mass flow rate and density of a fluid through a pipe. The Coriolis effect is the phenomenon that a mass moving in a rotating system experiences a force acting perpendicular to the direction of motion and to the axis of rotation. Accordingly, when a fluid flows through a Coriolis meter pipe section and is subjected to Coriolis acceleration via rotation, oscillation, or vibration into the pipe, the small amount of distortions caused by the deflecting force generated by the Coriolis inertial effect are measured by two optimally placed sensors on the Coriolis meter pipe, and the phase shift measured between the sensor signals is proportional to the mass flow rate of the fluid. The density of the fluid can then be determined based on the resonant frequency of the oscillation of the Coriolis meter pipe. Accordingly, Coriolis meters can be configured to output mass flow rate, density, temperature, and so forth.

If the dimensions of the bypass line 102 and the dimensions of the rich MEG, salt, and water line 20 and/or the lean MEG line 32 are known, or the effective-area ratio of the rich MEG, salt, and water line 20 and/or the lean MEG line 32 to the bypass line 102 (at the fluid-sampling opening) are known, then the mass flow rate of the aqueous liquid flowing through the rich MEG, salt, and water line 20 and/or the lean MEG line 32 can be determined. Except in unusual circumstances where there is a significant temperature difference between the bypass line 102 and the MEG, salt, and water line 20 and/or the lean MEG line 32, the temperature of the aqueous liquid flowing through the bypass line 102 can be assumed to be the same as that of the aqueous liquid flowing through the rich MEG, salt, and water line 20 and/or the lean MEG line 32.

An electromagnetic (EM) sensor 106, such as a microwave reflection sensor or a microwave transmission sensor, disposed in the rich MEG, salt, and water line 20, the lean MEG line 32, or the bypass line 102 may be used to determine the dielectric properties, such as conductivity and/or permittivity of the aqueous liquid in the rich MEG, salt, and water line 20, the lean MEG line 32, or the bypass line 102.

In the embodiment illustrated in FIG. 2, the MEG concentration monitoring system 100 includes a pure MEG injection system 108, which may be used for calibration. As shown, the pure MEG injection system 108 may include a pure MEG reservoir 110, a MEG pump to pressurize the MEG, and a metering valve 114, such as a chemical injection metering valve (CIMV) to control the flow of pressurized MEG into the bypass line 102. Periodically, the CIMV 114 may be used to inject pure MEG into the bypass line 102 to calibrate the Coriolis meter 104 and/or the electromagnetic sensor 106. Additional embodiments of the pure MEG injection system 108 are envisaged in which the CIMV 114 is replaced with a Coriolis meter 104. However, it should be understood that embodiments of the MEG concentration monitoring system 100 may omit the pure MEG injection system 108.

When the MEG concentration monitoring system 100 is disposed at the downstream location 38 (e.g., the MEG concentration monitoring system 100 is fluidly coupled or in fluid communication with the lean MEG line 32), the Coriolis meter 104 may be used to determine the density and temperature of aqueous liquid flowing through the lean MEG line 32 by measuring the fluid directly, or by measuring fluid flowing through the bypass line 102 and determining the density and temperature of aqueous liquid flowing through the lean MEG line 32. Because the aqueous liquid flowing the lean MEG line 32 includes very little or no salt, the MEG concentration can be determined based on the liquid density and the temperature with high accuracy (e.g., ±1%) if the Coriolis meter has a density accuracy of 0.6 mg/cc or better. Accordingly, in some embodiments, an electromagnetic sensor 106 may be omitted.

When the MEG concentration monitoring system 100 is disposed at the upstream location 36 (e.g., the MEG concentration monitoring system 100 is fluidly coupled to or in fluid communication with the rich MEG, salt, and water line 20), the Coriolis meter 104 may be used in conjunction with an electromagnetic sensor 106. Specifically, the Coriolis meter 104 may be used to determine the density and temperature of aqueous liquid flowing through the rich MEG, salt, and water line 20 by measuring the liquid directly, or by measuring liquid flowing through the bypass line 102 and determining the density and temperature of liquid flowing through the rich MEG, salt, and water line 20. The electromagnetic sensor 106 can be used to determine the conductivity and/or permittivity, and thus the salinity, of liquid flowing through the rich MEG, salt, and water line 20 by measuring the liquid directly, or by measuring liquid flowing through the bypass line 102 and determining the conductivity and/or permittivity and/or salinity of liquid flowing through the rich MEG, salt, and water line 20. Because the liquid flowing through the rich MEG, salt, and water line 20 includes non-negligible amounts of salt, salinity may be a variable used to determine MEG concentration. For example, MEG concentration can be determined if conductivity, permittivity, density, and salt concentration (NaCl concentration) are known. For example, the electrical conductivity (at 25 C) and the density (at 20 C) of the aqueous solution can be experimentally measured for several combinations of known MEG and salt concentrations, to generate models for determining MEG concentrations. In the range within 40-90% weight of MEG that is typical for MEG reclamation systems 10, such models may have up to 2% accuracy for MEG concentration, and up to 6% accuracy for the salt concentration. However, in some embodiments, temperature may be added to the model to improve accuracy.

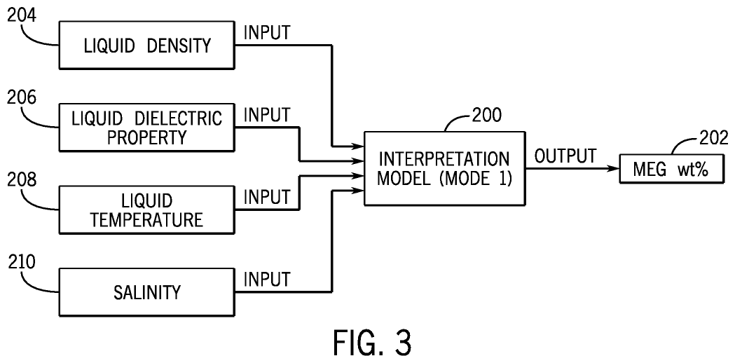

FIG. 3 is a schematic of an interpretation model 200 for determining MEG concentration 202 of an aqueous liquid based on various inputs 204, 206, 208, 210. As shown, the inputs 204, 206, 208, 210 to the interpretation model 200, which may be determined by one or more sensors, include liquid density 204, one or more liquid dielectric properties 206 (e.g. permittivity and/or conductivity), liquid temperature 208 and, in some embodiments, salinity (salt concentration) 210 (e.g. NaCl % weight). In some embodiments, based upon the location of the liquid within a known process, the salinity of the aqueous liquid may be assumed to be zero or otherwise negligible.

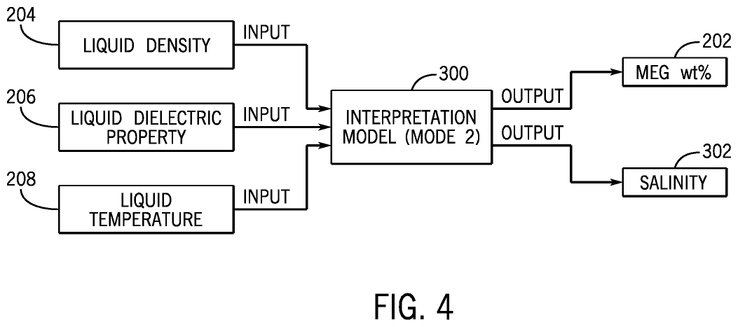

As previously discussed, the liquid density 204 may be obtained from a mass density meter, such as a Coriolis meter (that is capable of measuring liquid mass flow rate), or an oscillating U-tube density sensor. It is recommended that the density measurement accuracy be 0.5 mg/cc or better. The liquid dielectric properties 206 may include, for example, complex permittivity, which is a function of permittivity and conductivity, as measured by an electromagnetic sensor such as a microwave reflection sensor or a microwave transmission sensor operating at one or multiple radio frequencies. The liquid temperature 208 can be measured via the temperature probe on the Coriolis meter, or by a separate PT100 temperature probe in a thermowell installed close to the electromagnetic sensor, or by some other temperature sensor with sufficient measurement temperature accuracy (of 0.5 degC or better). The salinity 210 is the weight percentage of a dominant salt species, such as sodium chloride (NaCl), in the aqueous liquid or water phase. The salinity 210 can be an input to the interpretation model 200, as shown in FIG. 3, or an output, as shown in FIG. 4. In embodiments in which the salinity 210 is an input, the salinity 210 may be obtained by analyzing a water sample or aqueous liquid sample by using an appropriate lab analysis equipment, and so forth. Inputting the salinity 210 to the interpretation model 200, as shown in FIG. 3 may improve the accuracy of the of the determined MEG concentration 202.

The interpretation model 200 may be generated using experimental data, physics modelling, and/or mathematical regression modelling. Specifically, a set of (aqueous) liquid samples of various known MEG concentrations 202 and salinities 210 may be prepared. The densities 204 of the samples may be measured at different temperatures 208 (e.g., at a constant atmospheric pressure, such as latm). For each temperature 208, a three-dimensional surface polynomial fitting may be generated to derive the function for liquid density 204 with respect to MEG concentration 202 and salinity concentration (NaCl wt %) 210. The functions may then be generalized against temperature 208 by curve fitting. A MEG-water liquid dielectric model may be generated mathematically using, for example, a Debye equation, assuming negligible pressure dependence at relatively low pressures. By conducting experiments, measured permittivity and conductivity (liquid dielectric properties 206) for various MEG concentrations 202 and salinities 210 at different temperatures 208 can be obtained. Complex permittivity 206 and dielectric relaxation time can be calculated based on measured data. The results of dielectric relaxation time at a given frequency may be fitted against temperature 208, MEG concentration 202, and salinity 210 to generate a model for dielectric relaxation time. The mathematical regression interpretation model 200 is built by an appropriate linear regression method with the selected inputs and outputs using training data from the density model and the dielectric relaxation time model. The interpretation model 200 may be built by appropriate machine learning method(s) with the selected inputs and outputs using training data from the density model established based on experimental and/or modelling data and from the dielectric relaxation time model established based on experimental and/or modeling data.

FIG. 4 is a schematic of an interpretation model 300 for determining MEG concentration 202 and salinity 302 (e.g., NaCl % weight) based on various inputs 204, 206, 208. Accordingly, in the interpretation model 300 shown in FIG. 4, salinity 302 is an output of the interpretation model 300, rather than an input to the interpretation model 300. As similarly described with regard to FIG. 3, the inputs 204, 206, 208 to the interpretation model 300 include liquid density 204, one or more liquid dielectric properties 206 (e.g. permittivity and/or conductivity), and liquid temperature 208, and may be determined by one or more sensors.

The liquid density 204 may be obtained from a density sensor with an integrated temperature probe, such as a Coriolis meter or some other mass density sensor with an integrated temperature probe, such as an oscillating U-tube density sensor. The liquid dielectric properties 206 may be defined as complex permittivity, or some other function of permittivity and/or conductivity. The liquid dielectric properties 206 may be measured by an electromagnetic sensor such as a microwave reflection sensor or a microwave transmission sensor operating at one or multiple radio frequencies. The liquid temperature 208 may be measured via the Coriolis meter integrated temperature probe, or by some other temperature sensor, such as a PT100 probe in a thermowell installed close to the electromagnetic sensor.

As with the interpretation model 200 described with regard to FIG. 3, the interpretation model 300 of FIG. 4 may be generated using experimental data, physics modelling, and/or mathematical regression modelling. A set of liquid samples having known MEG concentrations 202 and salinities 302 may be prepared and the densities 204 of the samples measured at different temperatures 208. For each temperature 208, a three-dimensional surface polynomial fitting may be generated to derive the function for liquid density 204 vs. MEG concentration 202 and salinity (NaCl % weight) 302. The functions may be generalized against temperature 208 by curve fitting and a MEG-water liquid dielectric model generated mathematically based on the Debye equation.

Experimental data for measured permittivity and conductivity (liquid dielectric properties 206) for various MEG concentrations 202 and salinities 302 at different temperatures 208 can be generated or otherwise obtained. Complex permittivity and dielectric relaxation time can be calculated based on measured data. The results of dielectric relaxation time at a given frequency may be fitted against temperature 208, MEG concentration 202, and salinity 302 to generate a model for dielectric relaxation time. The mathematical regression interpretation model 300 is built by an appropriate linear regression method with the selected inputs and outputs using training data from the density model and the dielectric relaxation time model. The interpretation model 300 may be built by appropriate machine learning method(s) with the selected inputs and outputs using training data from the density model established based on experimental and/or modelling data and from the dielectric relaxation time model established based on experimental and/or modeling data.

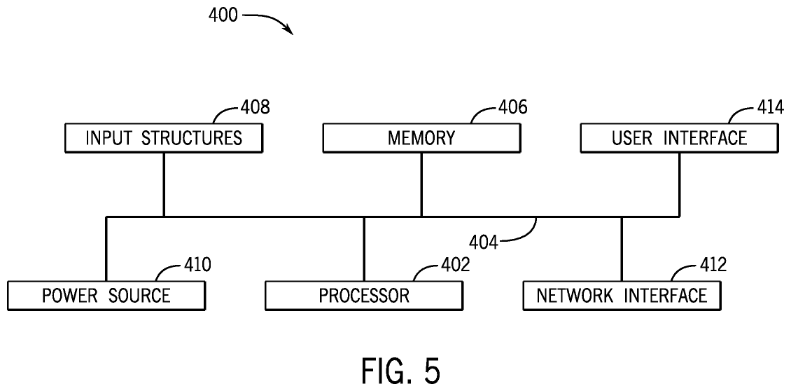

FIG. 5 is a block diagram of example components of a computing device 400 that could be used for data collection, data analysis, model generation, etc. As used herein, a computing device 400 may be implemented as one or more computing systems including laptop, notebook, desktop, tablet, or workstation computers, as well as server type devices or portable, communication type devices, such as cellular telephones and/or other suitable computing devices.

As illustrated, the computing device 400 may include various hardware components, such as one or more processors 402, one or more busses 404, memory 406, input structures 408, a power source 410, a network interface 412, a user interface 414, and/or other computer components useful in performing the functions described herein.

The one or more processors 402 may include, in certain implementations, microprocessors configured to execute instructions stored in the memory 406 or other accessible locations. Alternatively, the one or more processors 402 may be implemented as application-specific integrated circuits (ASICs), field-programmable gate arrays (FPGAs), and/or other devices designed to perform functions discussed herein in a dedicated manner. As will be appreciated, multiple processors 402 or processing components may be used to perform functions discussed herein in a distributed or parallel manner.

The memory 406 may encompass any tangible, non-transitory medium for storing data or executable routines. Although shown for convenience as a single block in FIG. 5, the memory 406 may encompass various discrete media in the same or different physical locations. The one or more processors 402 may access data in the memory 406 via one or more busses 404.

The input structures 408 may allow a user to input data and/or commands to the device 400 and may include mice, touchpads, touchscreens, keyboards, controllers, and so forth. The power source 410 can be any suitable source for providing power to the various components of the computing device 400, including line and battery power. In the depicted example, the device 400 includes a network interface 412. Such a network interface 412 may allow communication with other devices on a network using one or more communication protocols. In the depicted example, the device 400 includes a user interface 414, such as a display that may display images or data provided by the one or more processors 402. The user interface 414 may include, for example, a monitor, a display, and so forth. As will be appreciated, in a real-world context a processor-based system, such as the computing device 400 of FIG. 5, may be employed to implement some or all of the present approach, such as controlling devices, collecting data, analyzing data, storing data, generating/training models, applying models, and so forth.

The disclosed techniques are directed to using one or more sensors to determine a concentration of hydrate inhibitor, such as monoethylene glycol (MEG), in an aqueous liquid flowing through a conduit. Though present techniques are described as applied to a MEG reclamation system of an oil and gas well, it should be understood that the disclosed techniques may be utilized in other applications. A density sensor with an integrated temperature probe, such as a Coriolis meter, may be installed on a bypass line or a main line and configured to measure at least the density of the aqueous liquid flowing through the line and the temperature of the aqueous liquid flowing through the line. In some embodiments, a second sensor, such as an electromagnetic sensor may be installed on the bypass line or the main line and configured to measure a dielectric property (e.g., conductivity and/or permittivity) of the aqueous liquid flowing through the line. In some embodiments, the second sensor may also be configured to measure a salinity of the aqueous liquid flowing through the line. An interpolation model may be created based on experimental and modeling data and applied to the measured data to determine the MEG concentration of the aqueous liquid flowing through the line. In some embodiments, the interpolation model may be applied to the measured data to determine the salinity (e.g., salt concentration) of the aqueous liquid flowing through the line. In one embodiment, the line may be fluidly coupled to an output of a flash drum of a pretreament section of a MEG reclamation system for an oil and gas well, in which the liquid is a mixture of an aqueous MEG solution, sodium chloride, and water. In other embodiments, the line may be fluidly coupled to an output of a MEG distillation column of a regeneration section of a MEG reclamation system for an oil and gas well, in which the liquid is an aqueous MEG solution. Technical effects of implementing the disclosed techniques include improved control of a MEG reclamation system, resulting in more efficient operation of the MEG reclamation system. This may lead to, for example, fewer financial resources spent on new MEG, less wasted MEG, less time spent troubleshooting and optimizing the MEG reclamation system, less energy usage by the MEG reclamation system, and so forth.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform] ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a processor; and
a memory, accessible by the processor, the memory storing instructions that, when executed by the processor, cause the processor to perform operations comprising:
receiving, from a density sensor with an integrated temperature probe, first data indicative of a density of an aqueous liquid flowing through a line, and second data indicative of a temperature of the aqueous liquid flowing through the line;
applying an interpretation model to the first data and the second data to determine a concentration of a hydrate inhibitor of the aqueous liquid flowing through the line based on the density and the temperature of the aqueous liquid flowing through the line; and
generating an indication of the concentration of the hydrate inhibitor of the aqueous liquid flowing through the line.

2. The system of claim 1, wherein the hydrate inhibitor comprises monoethylene glycol, wherein the operations comprise:
receiving, from an electromagnetic sensor, third data indicative of a dielectric property of the aqueous liquid flowing through the line; and
applying the interpretation model to the first data, the second data, and the third data to determine the concentration of the hydrate inhibitor of the aqueous liquid flowing through the line based on the density, the temperature, and the dielectric property of the aqueous liquid flowing through the line.

3. The system of claim 2, wherein the dielectric property comprises a conductivity of the aqueous liquid flowing through the line, a permittivity of the aqueous liquid flowing through the line, or both.

4. The system of claim 2, wherein the system comprises the electromagnetic sensor, wherein the electromagnetic sensor comprises a microwave reflection sensor or a microwave transmission sensor.

5. The system of claim 2, wherein the operations comprise:
applying the interpretation model to the first data, the second data, and the third data to determine the concentration of the hydrate inhibitor of the aqueous liquid flowing through the line and a salinity of the aqueous liquid flowing through the line based on the density, the temperature, and the dielectric property of the aqueous liquid flowing through the line; and
generating an indication of the concentration of the hydrate inhibitor and the salinity of the aqueous liquid flowing through the line.

6. The system of claim 2, wherein the operations comprise:
receiving fourth data indicative of a salinity of the aqueous liquid flowing through the line; and
applying the interpretation model to the first data, the second data, the third data, and the fourth data to determine the concentration of the hydrate inhibitor of the aqueous liquid flowing through the line based on the density, the temperature, the dielectric property, and the salinity of the aqueous liquid flowing through the line.

7. The system of claim 1, comprising the density sensor with the integrated temperature probe, wherein the density sensor with the integrated temperature probe comprises a Coriolis meter.

8. The system of claim 1, wherein the line comprises a bypass line.

9. The system of claim 1, wherein the line is fluidly coupled to an output of a flash drum of a pretreament section of a hydrate inhibitor reclamation system for an oil and gas well, wherein the liquid comprises a mixture comprising an aqueous solution of hydrate inhibitor, water, and salt.

10. The system of claim 1, wherein the line is fluidly coupled to an output of a hydrate inhibitor distillation column of a regeneration section of a reclamation system for an oil and gas well, wherein the liquid comprises an aqueous hydrate inhibitor solution.

11. A method, comprising:
receiving, from a first sensor, first data indicative of a density of an aqueous liquid flowing through a line, and second data indicative of a temperature of the aqueous liquid flowing through the line;
receiving, from a second sensor, third data indicative of a dielectric property of the aqueous liquid flowing through the line;
applying an interpretation model to the first data, the second data, and the third data to determine a concentration of a hydrate inhibitor of the aqueous liquid flowing through the line based on the density, the temperature, and the dielectric property of the aqueous liquid flowing through the line; and
generating an indication of the concentration of the hydrate inhibitor of the aqueous liquid flowing through the line.

12. The method of claim 11, comprising:
applying the interpretation model to the first data, the second data, and the third data to determine the concentration of a hydrate inhibitor of the aqueous liquid flowing through the line and a salinity of the aqueous liquid flowing through the line based on the density, the temperature, and the dielectric property of the aqueous liquid flowing through the line; and
generating an indication of the concentration of the hydrate inhibitor and the salinity of the aqueous liquid flowing through the line.

13. The method of claim 11, comprising:
receiving fourth data indicative of a salinity of the aqueous liquid flowing through the line; and
applying the interpretation model to the first data, the second data, the third data, and the fourth data to determine the concentration of the hydrate inhibitor of the aqueous liquid flowing through the line based on the density, the temperature, the dielectric property, and the salinity of the aqueous liquid flowing through the line.

14. The method of claim 11, wherein the first sensor comprises a density sensor with an integrated temperature probe, wherein the density sensor with the integrated temperature probe comprises a Coriolis meter.

15. The method of claim 11, wherein the dielectric property comprises a conductivity of the aqueous liquid flowing through the line, a permittivity of the aqueous liquid flowing through the line, or both.

16. A non-transitory computer readable medium storing instructions that, when executed by a processor, cause the processor to perform operations comprising:
receiving, from a density sensor with an integrated temperature probe, first data indicative of a density of an aqueous liquid flowing through a line, and second data indicative of a temperature of the aqueous liquid flowing through the line;
receiving, from an electromagnetic sensor, third data indicative of a dielectric property of the aqueous liquid flowing through the line;
applying an interpretation model to the first data, the second data, and the third data to determine a concentration of a hydrate inhibitor of the aqueous liquid flowing through the line based on the density, the temperature, and the dielectric property of the aqueous liquid flowing through the line; and
generating an indication of the concentration of the hydrate inhibitor of the aqueous liquid flowing through the line.

17. The non-transitory computer readable medium of claim 16, wherein the operations comprise:
applying the interpretation model to the first data, the second data, and the third data to determine the concentration of the hydrate inhibitor of the aqueous liquid flowing through the line and a salinity of the aqueous liquid flowing through the line based on the density, the temperature, and the dielectric property of the aqueous liquid flowing through the line; and
generating an indication of the concentration of the hydrate inhibitor and the salinity of the aqueous liquid flowing through the line.

18. The non-transitory computer readable medium of claim 16, wherein the operations comprise:
receiving, from the second sensor, fourth data indicative of a salinity of the aqueous liquid flowing through the line; and
applying the interpretation model to the first data, the second data, the third data, and the fourth data to determine the concentration of the hydrate inhibitor of the aqueous liquid flowing through the line based on the density, the temperature, the dielectric property, and the salinity of the aqueous liquid flowing through the line.

19. The non-transitory computer readable medium of claim 16, wherein the dielectric property comprises a conductivity of the aqueous liquid flowing through the line, a permittivity of the aqueous liquid flowing through the line, or both.

20. The non-transitory computer readable medium of claim 16, wherein the line is part of a hydrate inhibitor reclamation system for an oil and gas well.
